(19) United States
(12) Patent Application Publication
(10) Pub. No.: US 2009/0308494 A1
(43) Pub. Date: Dec. 17, 2009

(54) HYDRATION STATION

(75) Inventor: Joshua D. Linn, Carson City, NV (US)

Correspondence Address: KELLY LOWRY & KELLEY, LLP, 6320 CANOGA AVENUE, SUITE 1650, WOODLAND HILLS, CA, 91367, US

(73) Assignee: HAWS CORPORATION, Sparks, NV (US)

(21) Appl. No.: 12/468,962

(22) Filed: May 20, 2009

Related U.S. Application Data
(60) Provisional application No. 61/073,236, filed on Jun. 17, 2008.

(51) Int. Cl. B65B 1/04; C02F 1/00

(52) U.S. Cl. 141/391; 210/85

(57) ABSTRACT

An improved hydration station comprises a wall mounted unit including a stationary lower body panel coupled to a drain, and a hinged upper body panel carrying a nozzle subassembly for dispensing water into a recess alcove defined cooperatively by the lower and upper body panels in response to user-insertion of a water-receiving receptacle into the alcove. The preferred wall unit includes a non-contact sensor for controlling water dispensing flow, and a preferred nozzle assembly includes at least one component having an antimicrobial additive. A preferred control timer automatically dispenses water in the event that the sensor does not detect a user-inserted receptable within a predetermined time interval, such as 24 hours. In addition, in a preferred form, lights on the unit are energized at one level during water dispensing, and at a second level when water is not being dispensed.

### BACKGROUND OF THE INVENTION

This invention relates primarily to improvements in the delivery and dispensing of drinking water, particularly to drinking water delivered in a public facility or place of work. This invention is intended to improve both the quality of the water issued and the means of delivery for this water.

Two kinds of drinking water dispensers are typically used in public areas. The first is the traditional drinking fountain, which emits a stream of water at a near-vertical angle from a purpose-built bubbler head, when the user activates a valve (usually with a button or lever); the user drinks directly from this stream. Any wasted water is usually caught in the basin of the fountain and is disposed of through a plumbed drain. The second type of dispenser is a point-of-use water cooler, which is usually a free-standing floor unit with a large removable water reservoir on the top. This water, which is often replenished on a regular basis by a drinking water service, is dispensed through a lever- or button-actuated tap into a cup, bottle, or similar receptacle. Any wasted water is caught in a simple basin; these often do not have plumbed drains.

There are problems associated with both types of dispensers. Both dispensers, for instance, usually have a substantial footprint, which can be a difficulty in offices or any areas where space is a premium commodity. Both types of dispenser, being used by a large number of individuals and having areas that are frequently wet, have a great capacity to be unsanitary. Drinking fountains, and some point-of-use water coolers, rely on an input of municipal water, which, depending on geography as well as the condition of the inlet plumbing, can be of inferior quality. Many point-of-use coolers utilize purified drinking water purchased on a regular basis, which is far more expensive per gallon than municipal water.

There is room, therefore, for improvement upon the delivery of public drinking water. The present invention addresses both the aforementioned problems and additional peripheral issues.

### SUMMARY OF THE INVENTION

In accordance with the invention, an improved drinking water dispenser includes a wall-mounted assembly 10 (see FIG. 1) with a vertically-oriented nozzle (denoted by reference numeral 78 in FIG. 4) that dispenses water downwardly. This nozzle 78 is located at the top of an alcove area; at the bottom of this alcove is a drain which is designed to be permanently plumbed (see FIGS. 2 and 6). The water that issues from the nozzle 78 is intended to be caught by a drinking water vessel (not shown) such as a glass or a bottle. An inline carbon filter 25 is used to remove sediment, as well as chlorine taste and odor, and a pressure regulator 37 assures a proper flow (see FIG. 2).

The unit is activated by means of an infrared sensor 46 below the nozzle 78, removing the need for any physical contact on the part of the user (see FIGS. 1 and 5). An increased signal return from the infrared sensor 46 indicates the presence of an object in the sensor path; this object must continue to trigger the sensor 46 for a very short delay period (which should allow the user to fully position his or her receptacle underneath the nozzle 78), after which a solenoid valve 35 will open (see FIG. 2), permitting water flow to the nozzle 78.

A timer feature 81 (see FIG. 10) is built into the main electronic board 68 (FIG. 9); this timer 81 resets every time the unit is used. If the timer 81 is allowed to reach twenty-four hours, the solenoid valve 35 will be activated automatically for a matter of seconds, flushing the water through the nozzle 78 and out of the system. In this manner, water is not permitted to remain in the unit for more than a 24-hour period, preventing the buildup of harmful bacteria over time.

The nozzle 78 comprises an assembly of molded nozzle components 40, 44, and 47 (FIG. 4) which may be constructed from a polymer with an antimicrobial additive which prevents the growth of bacteria. As a commercially-available example of a part constructed from a polymer with an antimicrobial additive is the CM3 modular ice machine, available from Scotsman Ice Systems, Vernon Hills, Ill., under the brand name AgION™.

A nozzle outlet 40 is equipped with a number of equally spaced mesh screens 41 and 42 designed to remove inherent turbulence from the water from and create a softer, more uniform flow (see FIG. 4). A nozzle housing 44 encases a small printed circuit board 45 with a number of LED lights 82 (see FIG. 11 and FIG. 12); these lights 82 normally pulse at a reduced brightness level to indicate that the electronics are functioning properly, with the produced light being externally visible in the upper region of the alcove immediately below the nozzle 78 near the top of the alcove, and generally in front of the infrared sensor 46. When the unit is activated upon operation of the infrared sensor 46 to open the solenoid valve 35 to initiate water flow, the LED lights 82 engage immediately at full brightness, both to indicate that the sensor 46 has been triggered and to further assist in the positioning of the user's receptacle beneath the nozzle 78.

The unit is mounted to a stainless steel back panel 13 (FIGS. 1-3) or the like, which is in turn attached to a galvanized steel mounting frame 11 (see FIG. 3). The frame 11 is sufficiently small to fit between two normally-spaced wall studs (not shown) of a wall 83, and is designed to be secured to these studs such that the stainless steel back panel 13 butts against an outside or outboard face of the wall 83.

In such a design that is mounted largely within the wall 83, it is desirable to have the ability to access the internal components and features with minimal effort and tools. Conversely, it is necessary for the unit 10 to be as secure from tampering as possible. As such, a main upper panel 15 (FIGS. 1 and 3) of the unit 10 opens on concealed hinges 16 (FIG. 3) to afford easy access. Two separate mechanisms hold the door or upper panel 15 in place during normal operation. One mechanism comprises a pair of conventional roller catches 17 which provide solid physical stops for the panel 15; local slots 84 (FIG. 3) formed in the side edges of the main upper panel 15 provide access and leverage assistance in releasing these roller catches 17 to open the upper panel 15, as by means of a small screwdriver (not shown) or the like. Secondly, a single hidden magnetic latch 18 interfaces with the steel back panel 13. A removable knob-shaped magnetic key 79 (FIG. 1), when placed in the proper position on the upper panel 15, actuates the hidden latch 18, moving it out of place and allowing the upper panel 15 to swing open freely. A typical magnetic latch system like this that is commercially available is the Tot-Lok System, marketed by Safety 1st, Columbus, Ind.

When the upper panel 15 is in an open position, a large cutout 85 (FIG. 3) in the steel back panel 13 offers access to the internal plumbing and other components. In this way, a number of maintenance items can be performed quickly and easily. The service life of the filter 25 can be assessed with a flow totalizer 21 (FIGS. 2, 7 and 13), and a filter cartridge (not shown) used in the inline carbon filter 25 can be changed as needed. In addition, the open upper panel 15 allows a drain grate 53 (FIGS. 1 and 6) to be unbolted and removed so that a drain 50 and strainer 54 (FIG. 6) can be cleaned and serviced. A lower panel 14 is permanently secured or constrained to the back panel 13, providing a robust waste plumbing configuration.

In essence, the present invention therefore comprises an unobtrusive system or means for delivering purified water through a sanitized system into the user's water receptacle. The invention requires essentially no floor space, and does not utilize the large water containers typically associated with many point-of-use coolers; rather, it fits easily and securely within a wall 83. There are a number of features which are intended to minimize the spread of bacteria and foreign particulates to the user, including a carbon filter 25, antimicrobial components (40, 44, and 47), non-contact activation by means of a “hands-off” sensor 46, and the automatic purging cycle built into a main circuit board 68 (FIG. 9). Maintenance is expedited and simplified by means of the hinged upper panel 15.

The versatility inherent to many of the components themselves cannot be overlooked. As an example, there are numerous methods that could be used with this design for hinging the upper panel 15. Virtually any type of non-mortised concealed hinge could be used with simple variations to the upper panel 15 and/or to the back panel 13. Similarly, if concealment is not required or desired, any standard hinges, such as piano hinges, could be used.

This same concept can be applied to the upper panel 15 retention hardware. It is not necessary to the design to use the roller-type catches, for instance. Any mechanical catch, such as a snap latch or grab catch, that actuates with the proper push-in/pull-out force, could be utilized (again, given some simple changes to the hinged panel 15 and/or to the back panel 13). Magnetic cabinet catches could be employed as well. In lieu of a magnetic latch and key system, a mechanical cam or key-actuated lock would suffice. The upper panel 15 could be secured to the back panel 13 using captive fasteners or threaded fasteners.

The plumbing fittings utilized throughout the design could easily be compression-style fittings or barbed fittings rather than push-in fittings.

The device itself could be actuated by means of a physical push button or slide that would either electrically or mechanically activate a solenoid valve in lieu of and/or in addition to the “hands-off” infrared sensor currently employed.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The attached drawings are intended to illustrate the invention. In many of the drawings, wiring has been removed for clarity. In such drawings:

FIG. 1 is a front elevation view of an improved hydration station or unit embodying the novel features of the invention, and including the entirety of the area which is visible to the end user;

FIG. 2 is a rear elevation view of the unit, including the internal plumbing;

FIG. 3 is a front perspective view of the unit with a main upper panel in the open position; such position being typical for the performance of routine maintenance;

FIG. 4 is an enlarged and fragmented vertical sectional view of a nozzle assembly and surrounding components;

FIG. 5 is an enlarged and fragmented sectional view of an infrared sensor and surrounding components;

FIG. 6 is an enlarged and fragmented sectional view of a drain area;

FIG. 7 is an enlarged and fragmented view of the area surrounding a flow totalizer;

FIG. 8 is an enlarged and fragmented view of a portion of the back or rear side of the unit depicting retention hardware for releasibly retaining the main upper panel;

FIG. 9 is an enlarged and fragmented view of the area around a main circuit board;

FIG. 10 is a flow chart describing the basic timer function of an automatic purging feature present in the written firmware of the processor of the main circuit board;

FIG. 11 is an enlarged horizontal sectional view illustrating details of a nozzle-mounted LED circuit board;

FIG. 12 is a flow chart describing the behavior of the LED circuit board assembly; and

FIG. 13 is a flow chart describing the function of the LED indicators associated with the flow totalizer.

### DETAILED DESCRIPTION OF THE PREFERRED EMBODIMENTS

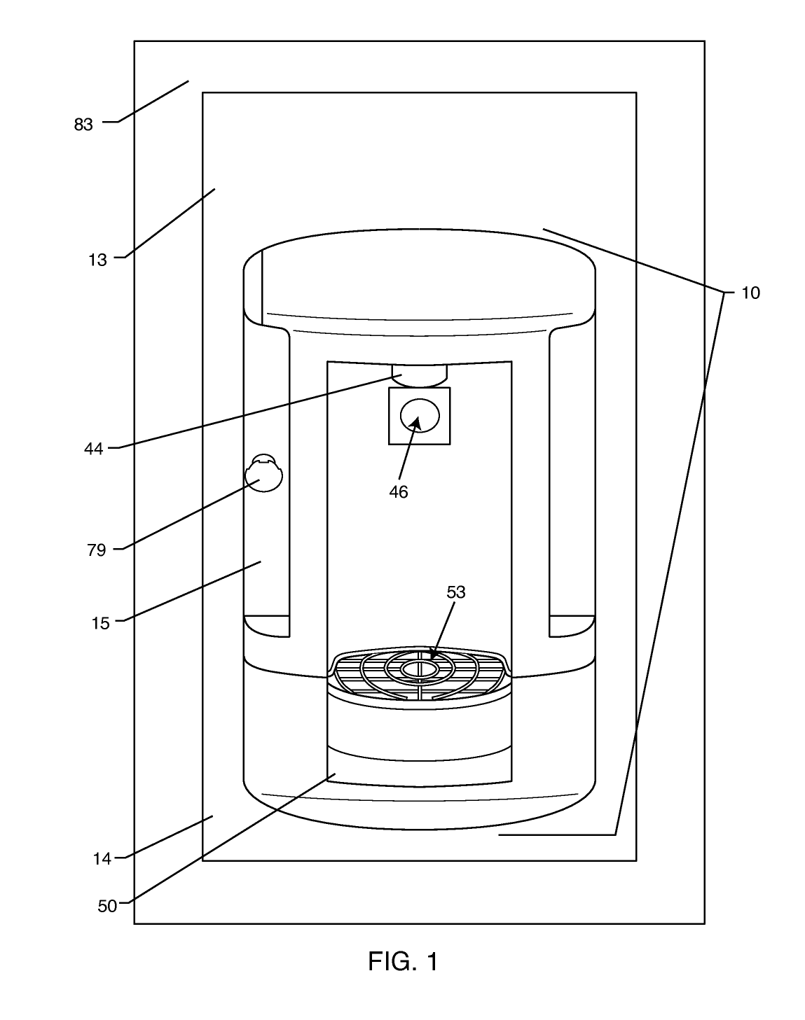

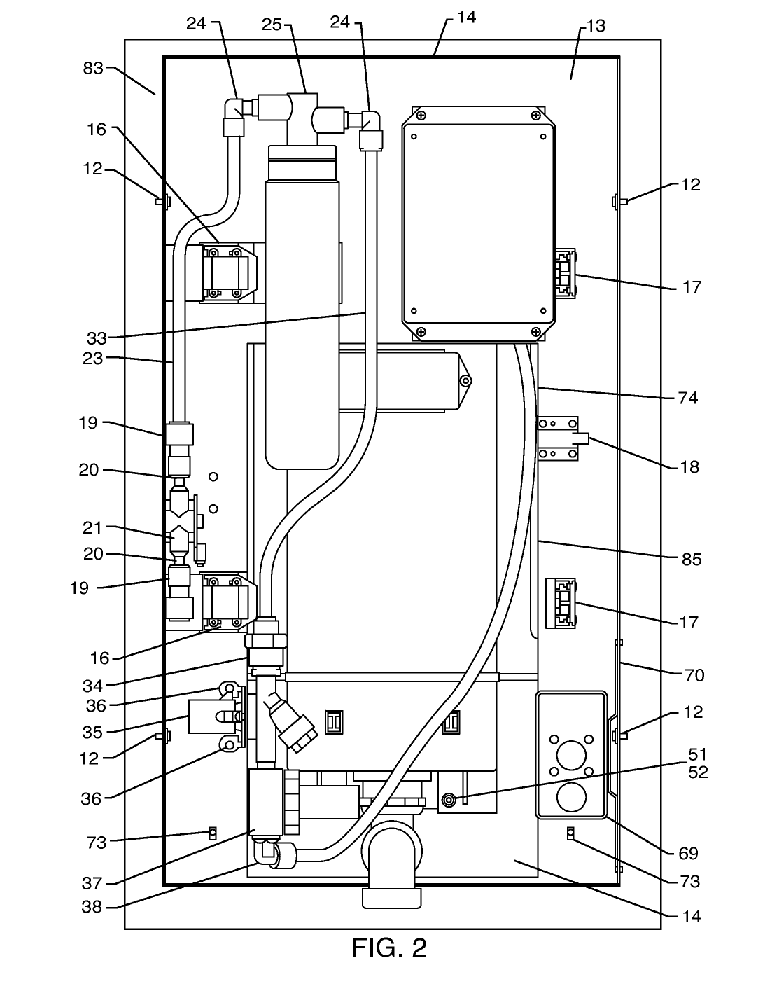

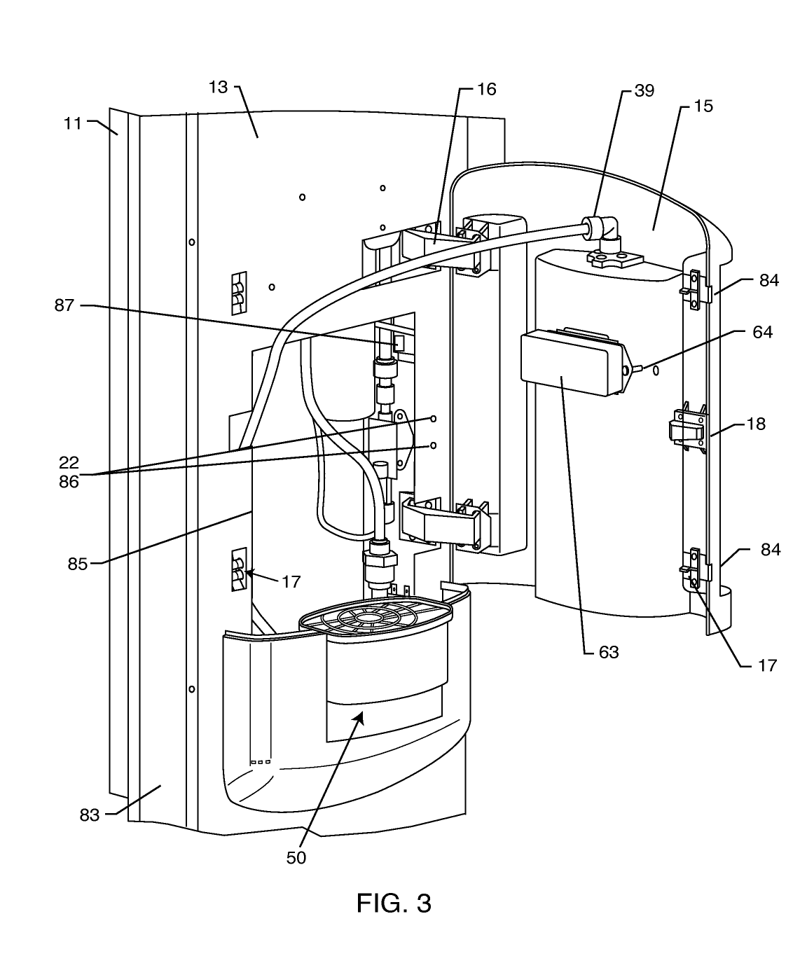

As seen in the attached drawings, an improved hydration station comprises a main water dispenser assembly (denoted by reference numeral 10) in the form of a wall-mounted unit; a rectangular mounting frame 11 is used to provide support and mounting for the device (FIGS. 2 and 3); this mounting frame 11 has a number of holes through which mounting screws may be affixed into wall studs (not shown) or similar items of a wall 83 or the like. Four panel clips 12 (FIG. 2) provide an interface between this mounting frame 11 and a sheet metal panel 13 (FIG. 1) formed from stainless steel or the like. This sheet metal panel 13 in turn butts against the wall 83 and provides central mounting for the main components of the unit 10.

The main body of the wall-mounted device or unit 10 is split into two separate contoured panels which are situated on the outboard or end-user side of the device (FIG. 1). A lower body panel 14 is a stationary piece which houses the drain and waste, while an upper body panel 15 can be actuated on concealed hinges 16 (FIG. 3) for movement between a normal closed position (FIG. 1) and an open position (FIG. 3). The lower panel 14 is secured to the sheet metal panel 13 with four self-tapping screws 73 (FIG. 2) or the like.

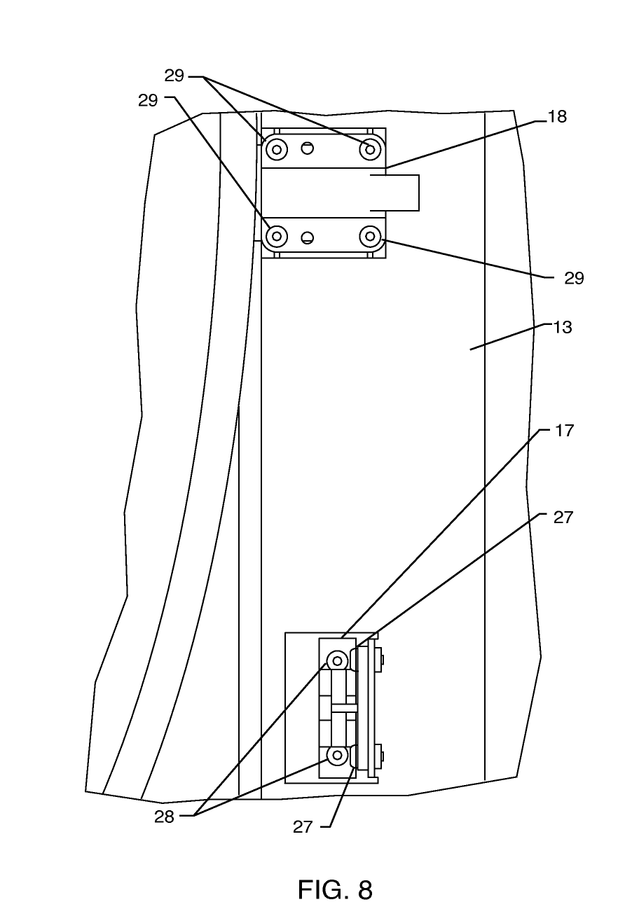

The hinged upper body panel 15 is shaped to define a recessed central alcove on the outboard or end-user side thereof; it is in this alcove that the end user places his or her water receptacle, such as a bottle or glass (not shown), activates the unit, and receives drinking water. This upper panel 15 is ordinarily retained in a closed position (FIG. 1) by means of two concealed mechanical roller catches 17 (shown in FIG. 3). These catches 17 are secured to the sheet metal panel 13 and to the upper body panel 15 with a number of machine screws 27 and self-tapping screws 28, respectively (FIG. 8). Two vertical slots 84 (FIG. 3) are provided locally in the left-hand edge of the upper body panel 15 for the purpose of opening the upper panel 15 (by overcoming the resistance of the mechanical roller catches 17) with a small leverage device such as a screwdriver (not shown). A single concealed magnetically-actuated latch 18 (FIG. 2) is also utilized to ensure that no unauthorized access to the unit occurs. The magnetic latch 18 is fastened to the upper body panel with several self-tapping screws 29 (FIG. 8). The magnetic latch 18 is actuated by means of a removable knob-shaped magnetic key 79 (FIG. 1) which can be applied over the magnetic latch on the front of the upper body panel 15. A typical magnetic latch system is commercially available is the Tot-Lok System, marketed by Safety 1st, Columbus, Ind. In the open position (FIG. 3), service and/or maintenance of the unit 10 is permitted by virtue of access to the rear side of the upper body panel 15 in addition to access to other system components (FIG. 2) by access through a central cut-out 85 formed in the sheet metal panel 13.

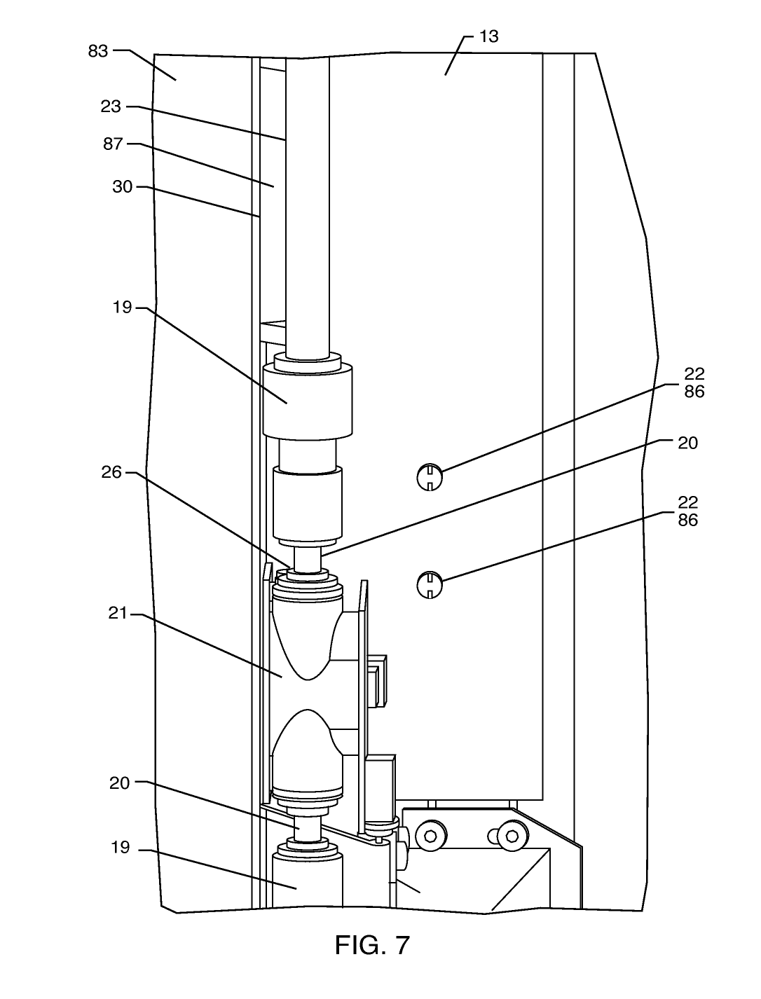

An inlet water connection is located at the left-hand side of the unit when viewing the unit from the back (FIG. 2). The user water inlet is permitted through a large circular opening nearby in the mounting frame 11. A quick-connect plastic fitting with a ⅜″ female end 19 is provided for the customer water inlet tubing; this fitting reduces to a ¼″ quick-connect female end on the opposite side (FIG. 2). A short length of ¼″ plastic tubing 20 connects this inlet fitting to an inlet port or inlet side of a battery-powered electronic flow totalizer device 21 (FIGS. 2 and 7). This flow totalizer 21 is fastened to the inner wall of the mounting frame 11 with hex nut 26 which is tightened onto an self-clinching threaded stud integral to the mounting frame 11 (FIG. 7); its corresponding lights such as LEDs 86, however, are secured to the front sheet metal panel 13 by means of snap-in panel-mount LED retainers 22 (FIGS. 2, 3 and 7). These LEDs 86 are hidden behind the upper panel 15 during normal operation, but are externally visible through their respective retainers 22 when energized or illuminated. One or both LEDs 86 activate when flow occurs; an illuminated green LED indicates general flow through the device, while an illuminated yellow LED indicates that a certain total volume setpoint has been exceeded (see FIG. 13). A battery case 87 adheres to the inside of the mounting frame 11 by means of adhesive transfer tape 30 (see FIGS. 3 and 7) or the like.

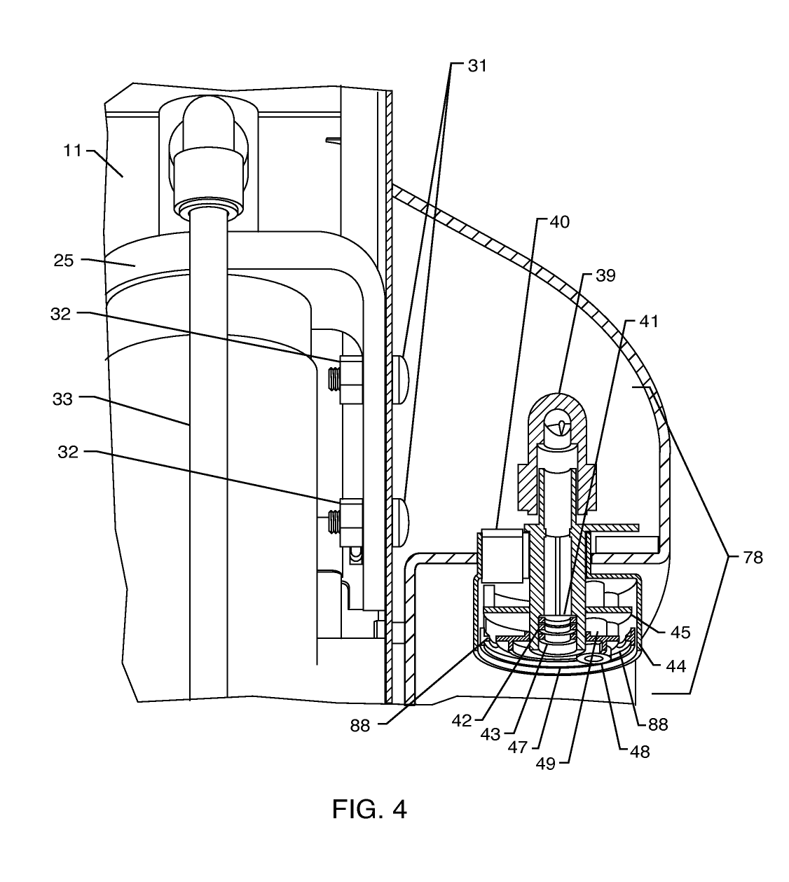

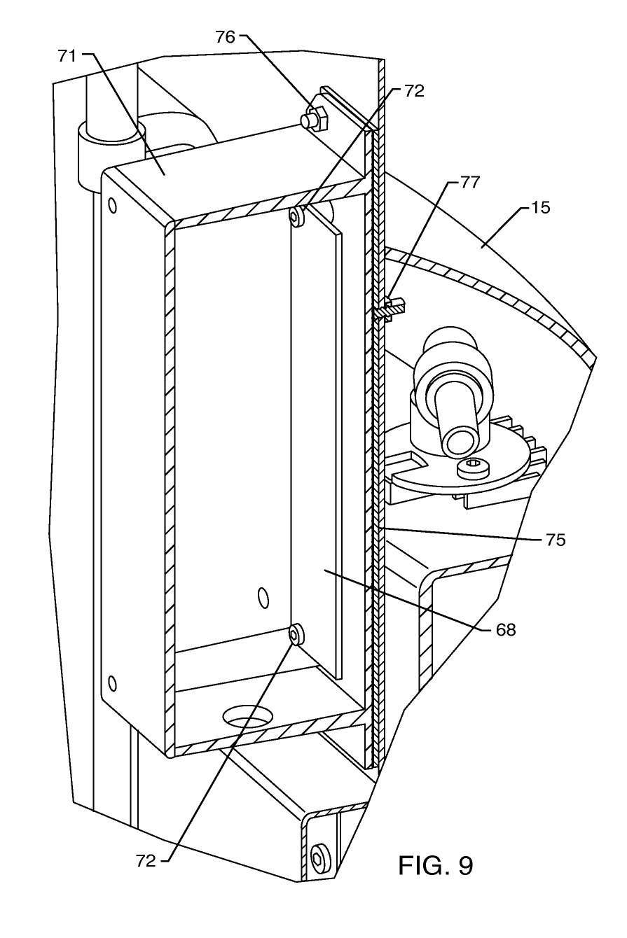

A second short length of ¼″ tubing 20 is affixed to an outlet port of the flow totalizer 21, followed by another ⅜″×¼″ female quick-connect fitting 19 (FIG. 2). A jogged length of ⅜″ copper tubing 23 then runs into the female end of ⅜″ plastic male/female quick-connect 90° elbow 24; this elbow 24 in turn is attached to the inlet side of an inline disposable-cartridge carbon filter 25 (FIG. 2). The head of the carbon filter is attached to the sheet metal panel 13 with two machine screws 31 and two nuts 32 (FIG. 4). A second ⅜″ male/female quick-connect 90° elbow 24 is attached to the female outlet port of the inline carbon filter 25 (FIG. 2); from the female end of this elbow 24, a length of ⅜″ plastic tubing 33 is connected. This plastic tubing 33 leads to the ⅜″ female quick-connect end of a ⅜″ female—½″ NPT female fitting 34. The ½″ NPT end interfaces with an electronically-controlled solenoid valve 35 held to the sheet metal panel 13 via two machine screws 36 (FIG. 2). The solenoid valve 35 is powered and controlled from a main circuit board 68 (FIG. 9). Screwed directly into the outlet of this solenoid valve 35 is a small pressure regulator 37 (FIG. 2); this allows the pressure and corresponding flow rate to be optimized in light of differing installation conditions such as inlet water pressure. A ⅜″ NPT male—⅜″ quick connect female 90° elbow 38 is attached on the NPT side to the outlet port of the pressure regulator 37 (FIG. 2).

A length of flexible ⅜″ plastic tubing 74 (FIGS. 2-3) is secured to the quick-connect side of the aforementioned elbow 38; this tubing 74 runs to ⅜″ female quick-connect 90° elbow 39 (FIG. 3). The outlet of this elbow 39 leads to the upper nozzle component 40 (FIG. 4) of the nozzle subassembly 78. At the end of the upper nozzle 40 (the zone which emits drinking water), there are a number of mesh screens 41 and spacers 42 in alternating series; this is designed to lessen turbulent flow. A spacer 43 at the farthest extremity, or downstream end, is engaged into the upper nozzle by means of interference fit; this is necessary to retain the screens 41 and spacers 42 behind it (FIG. 4).

The upper nozzle component 40 has a straight cylindrical section designed to interface with a ⅜″ female quick-connect fitting. Beneath this is a mounting flange and then the lower segment of the nozzle, through which the drinking water issues. There are two self-tapping screws (not shown) that traverse through-holes in the mounting flange of the upper nozzle component 40 and in the roof of the dispenser alcove in the upper body panel 15 and screw into the appropriate bosses in a lower nozzle component 44 (FIG. 4), effectively positioning and retaining the entire nozzle subassembly 78. The lower nozzle 44 is generally cup-shaped and inverted, with the opening facing downward. There is also a cylindrical thin-walled boss extending from the top to retain and guide the upper nozzle 40. Lying alongside this cylindrical boss is a thin-walled rectangular boss that corresponds to a similarly-shaped window in the upper nozzle 40; these spaces are designed to permit the passage of any wiring or similar item from the upper nozzle 40 through the upper panel 15 to the internal side of the unit.

At least one and preferably all of these water-contacting nozzle subassembly components are constructed from a material including a selected antimicrobial additive. One commercially-available example of a part constructed from a polymer with an antimicrobial additive is the CM3 modular ice machine, available from Scotsman Ice Systems, Vernon Hills, Ill., under the brand name AgION™.

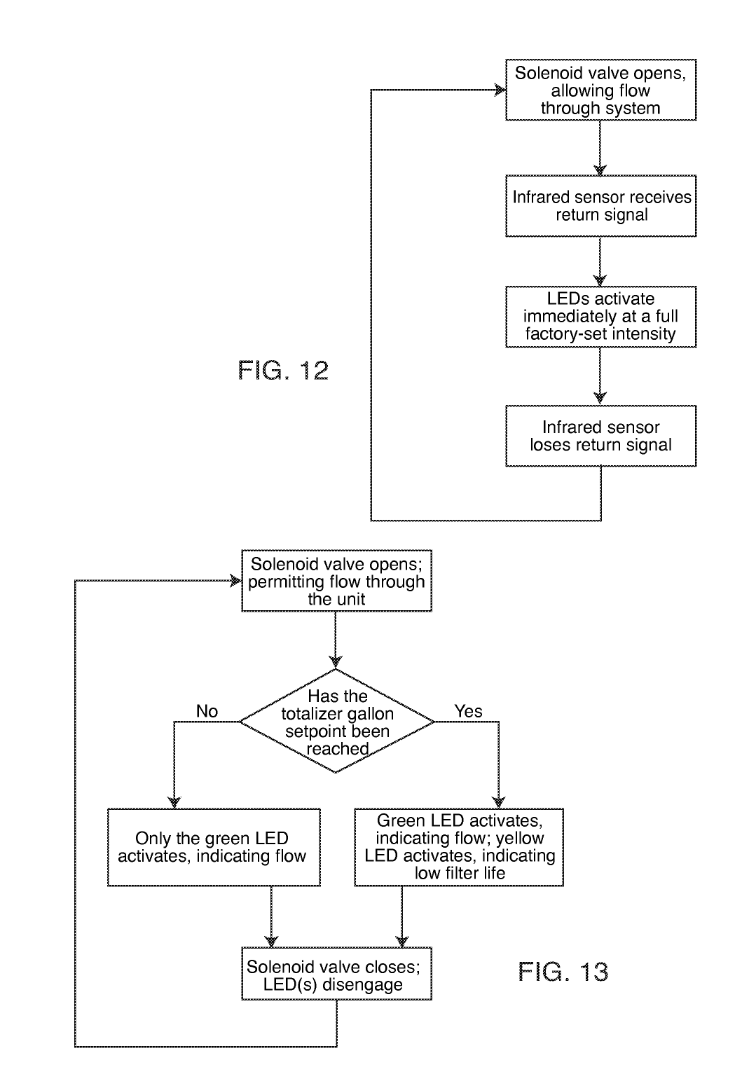

A small circular circuit board 45 (FIGS. 4 and 11) with four lights such as LED 82 (see FIG. 11) is held inside the lower nozzle component 44 against a number of radially-positioned rectangular standoffs; these lights 82 are activated by an infrared sensor 46 to guide the user to optimally receive the drinking water (see FIGS. 4 and 12). These LEDs 82 are programmed and operated to continuously flash at a decreased intensity to indicate that the electronics are properly functioning, wherein this flashing light is visible within the upper region of the alcove at the front or outboard side of the upper hinged panel 15. The LED circuit board 45 is controlled and powered from the main circuit board 68 (FIG. 9).

A protective cap 47 fits over the large lower opening of lower nozzle 44; it has openings to permit both the passage of light from the LEDs 82 on the circuit board 45 and the upper nozzle 40 (FIG. 4). This cap 47 is held in place with two self-tapping countersink screws 48; these screws interface with their corresponding bosses in the lower nozzle 44. There are two unthreaded broaching standoffs 49 pressed into the LED circuit board 45 intended to maintain the spacing between the LED circuit board 45 and the cap 47; the two countersink screws 48 pass through these standoffs 49.

An upwardly open, generally cup-shaped drain basin 50 (FIGS. 1, 3 and 6) is disposed directly beneath the nozzle subassembly 78; its general shape compliments both the outer contours of the lower body panel 14 and in the contours of the alcove defined cooperatively between the stationary lower body panel 14 and the hinged upper body panel 15 (FIG. 1). The drain basin 50 fits into the lower body panel 14 from the front of the panel; there are several I-shaped locating bosses which interface with rectangular holes in the lower body panel 14. Two self-tapping screws 51 (FIG. 2) fit into the screw bosses in the back of the drain basin 50; these bosses slide into larger bosses in the lower body panel 14. Each self-tapping screw 51 butts against a washer 52 which prevents the drain basin 50 from being removed from the front of the unit 10.

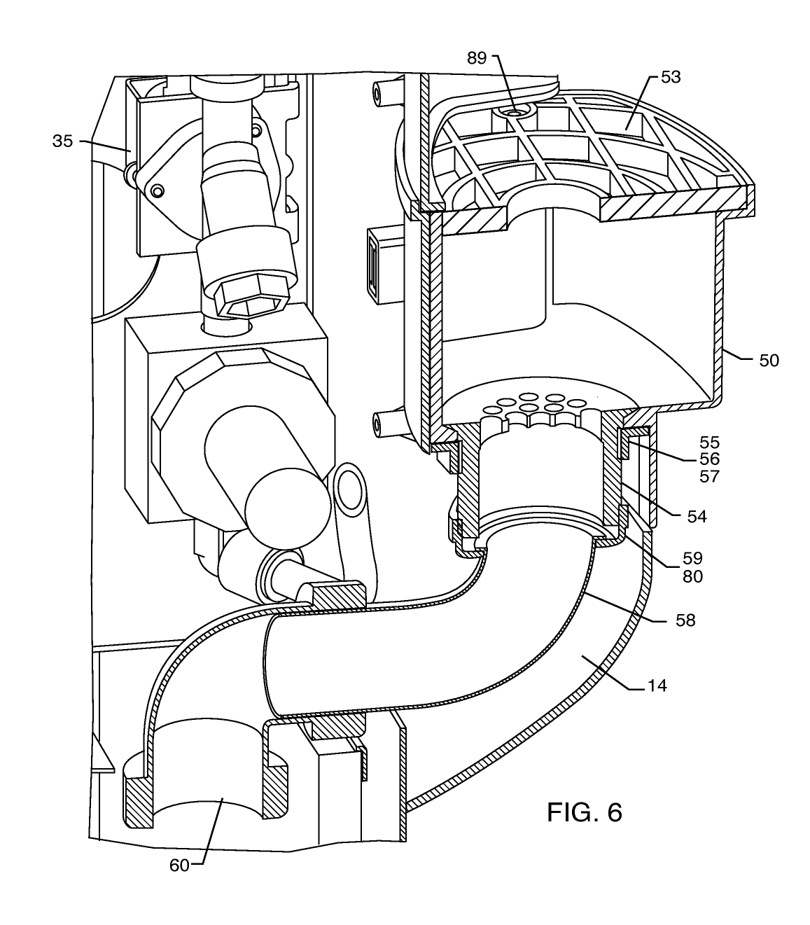

A drain grate 53 fits into the top of the open cup of the drain basin 50; the bottom of this grate 53 is held up by several flats inside the drain basin 50 (FIG. 6). There are two counterbored holes in the top of the drain grate 53. Two self-tapping screws 89 pass through these holes and screw into the drain basin 50; these screws must be removed if the drain is to be serviced. It should also be noted that the geometry of the bottom of the hinged upper body panel 15 overlies and obstructs, and thus prevents the removal of the drain grate 53 unless the upper body panel 15 is open (FIG. 6).

The drain basin 50 has a sloped bottom with a large countersunk D-hole formed therein; this hole receives and cradles a threaded drain strainer 54. A rubber washer 55 and a fiber washer 56 are sandwiched against the bottom of the drain basin 50 by a nut 57 which is threaded onto the drain strainer 54 (FIG. 6); these washers are intended to seal the opening around the drain strainer 54. A flanged 90° waste bend 58 is held against the bottom of the drain strainer 54 with a cupped nut 80; a rubber O-ring 59 prevents leaking from this interface. The waste plumbing is completed by an 1¼″ female slip joint waste elbow 60 (FIG. 3) adapted for coupling to a suitable drain site (not shown).

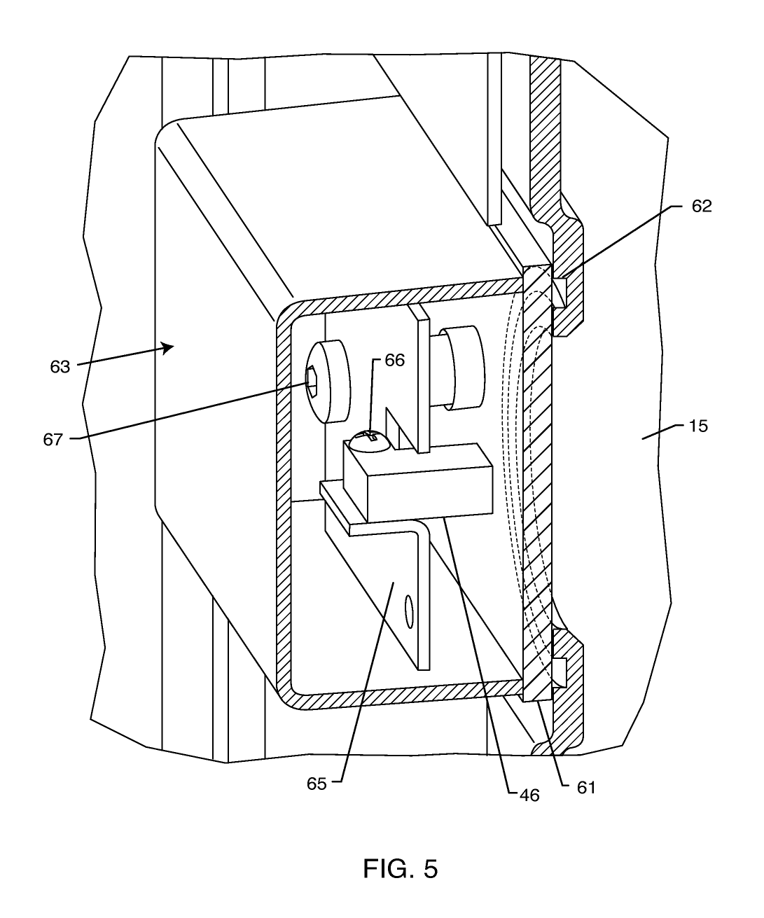

There is a circular hole in the back of the alcove on the upper body panel 15 at a position spaced a short distance beneath the nozzle subassembly 78; a rectangular tinted plastic window 61 (FIG. 5) butts against the back of this area. A rubber O-ring 62 fits into an O-ring groove in the back of the upper body panel 15 that surrounds this circular hole; this O-ring 62 will prevent moisture from entering the unit through the window area. A small open electrical box 63 sandwiches the plastic window 61 and the O-ring 62 against the upper body panel 15. This electrical box 63 is flanged on its left and right sides with through holes in the flanges to permit two self-tapping screws 64 to interface with screw bosses on the main upper body panel 15 and hold the box in place (FIGS. 3 and 5).

Inside the box 63, there is a small rectangular sheet metal mount 65 for the infrared sensor 46. The infrared sensor 46 is mounted against a folded tab in the sheet metal mount 65 and is held in place by two sheet metal screws 66. The infrared sensor 46 is oriented such that it faces the window 61, permitting it to sense the presence of a nearby object (FIG. 5).

The sheet metal sensor mount 65 is attached to the upper body panel 15 by means of two self-tapping screws 67; there are clearance holes in the tinted sensor window 61 for the screw bosses for these self-tapping screws 67 (FIG. 5). The IR sensor 46 is connected to the main circuit board 68 for power and signal transmission.

An AC input power is connected to the unit inside an electrical box with cable grips 69 (FIG. 2). This box 69 is located on the mounting frame 11 in the lower right-hand corner facing the back of the unit, and is held in place with two machine screws 70. User power hookups are permitted through a large circular hole nearby in the mounting frame 11.

The main circuit board 68 is contained within a large plastic electrical box 71 (FIG. 9). This box has two holes drilled through the lower wall; the hole to the left (facing the back of the unit) permits the passage of the low-voltage wiring, such as the sensor wires and the LED wires. The hole to the right permits the passage of the high-voltage power wiring. The main electrical box 71 includes a cover with mounting screws in the corners. There are four screw bosses in the base of the electrical box 71; these allow the attachment of the main circuit board 68 by the use of four self-tapping screws 72 (FIG. 9).

The purpose of the main circuit board 68 is to control the normal operating functions of the unit. The sole electronic component that operates outside the control of the main circuit board 68 is the battery-powered flow totalizer 21, which can be completely self-contained. The main circuit board 68 contains the firmware code used to govern the unit and interprets the signals from the infrared sensor 46 and activates or deactivates the LED board 45 and the solenoid valve 35 as necessary. The circuit board 68 activates the LED board 45 immediately upon acquisition of an infrared signal and opens the solenoid valve 35 after a selected time delay, typically approximately one second, of a maintained infrared signal.

The circuit board 68 receives the input power for the unit and distributes power to the peripheral electrical devices. It also contains means such as dip switches (not shown) for controlling the brightness level of the LED assembly 45 toggling a continuous power signal for the LED assembly 45, and providing sensitivity adjustment for the infrared sensor 46.

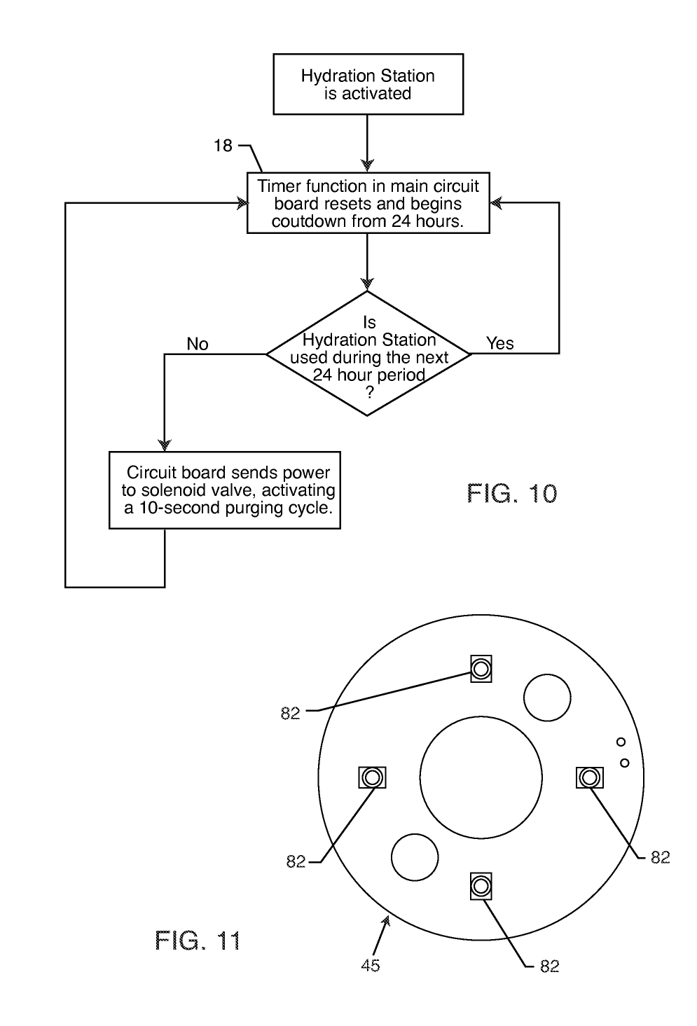

The firmware associated with the circuit board 68 also provides a convenient automatic purging feature. Its function is laid out in FIG. 10. Every time the unit is used to dispense water, the timer function resets itself and begins counting up. If the total time is allowed to reach 24 hours without a water dispense cycle, the circuit board 68 will send power to the solenoid valve 35 for approximately ten seconds, allowing the valve 35 to open and the water within the unit to be purged out the nozzle 78. This prevents standing water from remaining in the unit for more than 24 hours, which aids in the prevention of bacteria growth.

The electrical box 71 is attached to a small sheet metal plate 75 (FIG. 9). This plate has four integral broaching studs which fit through the mounting holes on the flanges of the electrical box 71. Hex nuts 76 hold the electrical box 71 to the sheet metal plate 75. The sheet metal plate 75 is secured to the main sheet metal panel 13 with two more integral broaching studs that face the opposite direction. These studs pass through the main sheet metal panel 75 and are held in place with hex nuts 77 (FIG. 9). The purpose of this sheet metal mounting plate 75 is to allow secure mount of the electrical box while keeping all fasteners out of sight when the unit is viewed from the front.

FIG. 12 is a flow chart illustrating the operation of the LED's 82 in response to actuation of the infrared sensor 46, all under the control of the main circuit board 68. As previously described, the LED's 82 are normally energized to flash or blink at partial power, to indicate that the sensor 46 has not been activate, while providing sufficient illumination of the upper portion of the alcove region to assist in placement of a water-receiving vessel. When the sensor 46 is activated by such placement of the water-receiving vessel in close proximity thereto, the solenoid valve 35 is opened to initiate water dispense flow. At this moment, the LED's 82 are energized for substantially full-power illumination, preferably without flashing. When the dispense cycle has concluded, the main circuit board 68 de-activates the infrared sensor 46, closes the solenoid valve 35, and returns to the LED's 82 to their normal part-power blink mode.

FIG. 13 depicts operation of the flow totalizer 21, as a function of water dispensing under the control of the main circuit board 68. As shown, when the solenoid valve 35 is opened to initiate water dispense flow, the totalizer 21 responds by summing and storing the gallonage of water dispensed using a known time-flow algorithm. If the summed/stored gallonage dispense total is below a predetermined maximum for the associated filter 25, the green LED 86 is activated during the dispense cycle. However, if the summed/stored dispense total exceeds the predetermined maximum, then the yellow LED 86 is additionally illuminated during the dispense cycle. Such actuation of the LED's 86 provides a clear indication that the gallonage cycle of the filter 25 has been reached or exceeded, and that filter replacement is warranted.

A variety of further modifications and improvements in and to the improved hydration station of the present invention will be apparent to persons skilled in the art. Accordingly, no limitation on the invention is intended by way of the foregoing description and accompanying drawings, except as set forth in the appended claims.

What is claimed is:

1. A hydration station, comprising:
a wall mounted unit having means for mounting onto a building wall, said mounting means including a back panel;
said wall mounted unit further comprising a main body including a stationary lower body panel defining an upwardly open drain, and a hinged upper body panel movable between a normal closed position for dispensing water and an open position for facilitated maintenance; and
said upper body panel having a nozzle subassembly for dispensing water, said nozzle subassembly being disposed in generally vertically spaced relation with said drain, when said upper body panel is in said closed position.

2. The hydration station of claim 1 wherein said wall mounted unit further comprises a mounting frame having a size and shape to file within a building wall, said back panel being supported relative to said wall by said mounting frame.

3. The hydration station of claim 1 wherein said lower and upper body panels cooperatively define a user-accessible recessed alcove, said drain and said nozzle subassembly being positioned respectively at the lower and upper ends of said recessed alcove, said recessed alcove having a sufficient size to accommodate reception of a user-inserted water-receiving receptacle.

4. The hydration station of claim 3 further comprising non-contact sensor means for controlling water flow to and through said nozzle subassembly.

5. The hydration station of claim 4 wherein said non-contact sensor means comprises a light sensor for detecting the presence of a user-inserted water-receiving receptacle into said recessed alcove.

6. The hydration station of claim 5 further comprising a tinted window carried by said upper body panel, said light sensor being mounted onto said upper body panel at a position disposed behind said tinted window.

7. The hydration station of claim 5 wherein said light sensor comprises an infra-red light sensor mounted in spaced relation a short distance below said nozzle subassembly.

8. The hydration station of claim 5 further including control means for time delay dispensing of water to and through said nozzle subassembly in response to detection of a user-inserted water-receptacle into said alcove.

9. The hydration station of claim 8 further including timed control means for automatically dispensing water to and through said nozzle subassembly in response to the absence of water dispensing for a predetermined time period.

10. The hydration station of claim 9 wherein said predetermined time period is 24 hours.

11. The hydration station of claim 1 wherein said nozzle subassembly includes at least one water-contacting nozzle component constructed from a material including an antimicrobial additive.

12. The hydration station of claim 1 further comprising at least one hinge for hingedly supporting said upper body panel for swinging movement between said closed and open position, said at least one hinge being concealed from a user-accessible side of said unit when said upper body panel is in said closed position.

13. The hydration station of claim 12 further comprising at least one magnetically actuated latch for normally retaining said upper body panel in said closed position.

14. The hydration station of claim 1 wherein said drain comprises a drain basin removably carried by said lower body panel, said drain basin being removable when said upper body panel is in said open position and blocked against removal when said upper body panel is in said closed position.

15. The hydration station of claim 5 further comprising control means for energizing at least one light at a relatively high power level in response to detection of a user-inserted water-receiving receptacle into said recessed alcove, and for energizing said at least one light at a relatively reduced power level in response to the absence of detection of a user-inserted water-receiving receptacle into said recessed alcove.

16. The hydration station of claim 15 wherein said reduced power level comprises a flashing on-off light energization mode.

17. The hydration station of claim 1 further comprising filter means carried by said unit in a position concealed with said upper body panel is in said closed position, said filter means producing relatively purified water supplied to said nozzle subassembly for dispensing, and control means including at least one light viewable from a user-accessible side of said unit and energizable to indicate the status of said filter means.

18. A hydration station, comprising:
a wall mounted unit having means for mounting onto a building wall, said mounting means including a back panel;
said wall mounted unit further comprising a main body including a stationary lower body panel defining an upwardly open drain, and a hinged upper body panel movable between a normal closed position for dispensing water and an open position for facilitated maintenance; and
said upper body panel having a nozzle subassembly for dispensing water, said nozzle subassembly being disposed in generally vertically spaced relation with said drain, when said upper body panel is in said closed position;
said lower and upper body panels cooperatively define a user-accessible recessed alcove, said drain and said nozzle subassembly being positioned respectively at the lower and upper ends of said recessed alcove, said recessed alcove having a sufficient size to accommodate reception of a user-inserted water-receiving receptacle; and
non-contact sensor means for controlling water flow to and through said nozzle subassembly.

19. The hydration station of claim 18 wherein said sensor means comprises an infra-red light sensor mounted in spaced relation a short distance below said nozzle subassembly.

20. The hydration station of claim 18 further including control means for time delay dispensing of water to and through said nozzle subassembly in response to detection of a user-inserted water-receptacle into said alcove.

21. The hydration station of claim 20 further including timed control means for automatically dispensing water to and through said nozzle subassembly in response to the absence of water dispensing for a predetermined time period.

22. The hydration station of claim 18 further comprising at least one hinge for hingedly supporting said upper body panel for swinging movement between said closed and open position, said at least one hinge being concealed from a user-accessible side of said unit when said upper body panel is in said closed position.

23. The hydration station of claim 18 wherein said drain comprises a drain basin removably carried by said lower body panel, said drain basin being removable when said upper body panel is in said open position and blocked against removal when said upper body panel is in said closed position.

24. The hydration station of claim 18 further comprising control means for energizing at least one light at a relatively high power level in response to detection of a user-inserted water-receiving receptacle into said recessed alcove, and for energizing said at least one light at a relatively reduced power level in response to the absence of detection of a user-inserted water-receiving receptacle into said recessed alcove.

25. A hydration station, comprising:
a wall mounted unit comprising a main body including a lower body panel defining an upwardly open drain, and an upper body panel movable between a normal closed position for dispensing water and an open position for facilitated maintenance; and
said upper body panel having a nozzle subassembly for dispensing water, said nozzle subassembly being disposed in generally vertically spaced relation with said drain;
said lower and upper body panels cooperatively define a user-accessible recessed alcove, said drain and said nozzle subassembly being positioned respectively at the lower and upper ends of said recessed alcove, said recessed alcove having a sufficient size to accommodate reception of a user-inserted water-receiving receptacle; and
non-contact sensor means for controlling water flow to and through said nozzle subassembly.

26. The hydration station of claim 25 wherein said sensor means comprises an infra-red light sensor mounted in spaced relation a short distance below said nozzle subassembly.

27. The hydration station of claim 25 further including control means for time delay dispensing of water to and through said nozzle subassembly in response to detection of a user-inserted water-receptacle into said alcove.

28. The hydration station of claim 27 further including timed control means for automatically dispensing water to and through said nozzle subassembly in response to the absence of water dispensing for a predetermined time period.

29. The hydration station of claim 25 further comprising control means for energizing at least one light at a relatively high power level in response to detection of a user-inserted water-receiving receptacle into said recessed alcove, and for energizing said at least one light at a relatively reduced power level in response to the absence of detection of a user-inserted water-receiving receptacle into said recessed alcove.
